(19) United States
(12) Patent Application Publication
(10) Pub. No.: US 2018/0204272 A1
(43) Pub. Date: Jul. 19, 2018

(54) Enabling Secure End-User Purchases From Email

(71) Applicant: Matthew Alan Sargeant, New York, NY (US)

(72) Inventor: Matthew Alan Sargeant, New York, NY (US)

(21) Appl. No.: 15/868,209

(22) Filed: Jan. 11, 2018

Related U.S. Application Data
(60) Provisional application No. 62/445,813, filed on Jan. 13, 2017.

(51) Int. Cl. G06Q 30/06; H04L 12/58

(52) U.S. Cl. CPC G06Q 30/0641; H04L 61/2007; H04L 51/22; G06Q 30/0633

(57) ABSTRACT

This disclosure relates to a server system that can enable an electronic commerce store to seamlessly sell one or more products and/or one or more services to a user of an electronic commerce application or website in response to only a few actions performed by the user while accessing a marketing email specific to the user. The sale is seamless because it requires only a few actions (e.g., one or two clicks) by a user registered with the electronic commerce application to complete the purchase, thereby minimizing the effort required by the user during the purchase. The server system can enable a host of the electronic commerce application to add or integrate this functionality without modifying preexisting payment systems for the electronic commerce application.

### RELATED APPLICATION

This disclosure claims priority, under 35 U.S.C. § 119, to U.S. Provisional Patent Application Ser. No. 62/445,813, entitled “Systems And Methods For Enabling Secure End-User Purchases From Email” and filed on Jan. 13, 2017, the entire contents of which are incorporated by reference herein.

### TECHNICAL FIELD

Implementations of the present subject matter relate to a server system that can enable an electronic commerce store to seamlessly sell one or more products and/or one or more services to a user of an electronic commerce application or website in response to only a few actions performed by the user while accessing a marketing email specific to the user, thereby minimizing the effort required by the user during the purchase.

### BACKGROUND

This section is intended to introduce various aspects that may be related to implementations of the present subject matter, which are described below. This discussion is believed to be helpful in providing background information to facilitate a better understanding of the various aspects of implementations of the present subject matter. Accordingly, it should be understood that these statements are to be read in this light, and not as admissions of prior art.

A typical electronic commerce (also referred to as ecommerce herein) purchase is completed only after a user has entered payment details and shipping details on a website where they want to complete a purchase. This information can be securely stored for future purchases but still requires a user to log-in and continue through multiple steps of the checkout to confirm the payment details and shipping details. Current email marketing programs send details about a product (which can be a general marketing (or ‘broadcast’) email or based on a triggered event, e.g., cart abandonment) and then require a user to complete checkout by logging in and confirming payment/shipping details through a standard process.

If the user has installed a mobile app from the ecommerce company, check out through the app can facilitate faster checkout but the process is not optimized when individuals wish to purchase after receiving an email (without installing an app in advance). Although entering billing and shipping details are not required for existing users who have stored this information, it can still take over ten (10) steps to complete a purchase on an ecommerce website after receiving an email with a product they wish to purchase. Example steps include, but are not necessarily limited to:
i) User opens email to read. User identifies product he/she intends to purchase, then
ii) User clicks on product link, then
iii) User is redirected to the associated product page on the website using a web browser. User scrolls to find the ‘add to cart’ button and clicks, then
iv) User is shown a page to confirm the product has been added to cart. Options are Checkout or Continue shopping. User clicks ‘checkout,’ then
v) User is shown the cart summary page. User reviews the order and clicks ‘continue checkout’. Then
vi) User is taken to a page to log in. Options are selecting between ‘new user’ and ‘existing user’. User clicks ‘Existing user’ then
vii) User is shown fields to log in as an existing user. Fields are username (often email address) & password to log in. User enters email and password and clicks log in, then
viii) User is logged in and shown shipping address options to select. User has saved shipping details from his/her previous purchase. User selects the appropriate shipping address and clicks continue. Then
ix) User is shown shipping method options. There is usually several options including default and express. User selects preferred shipping method and associated cost and clicks continue. Then
x) User is given the options of selecting a payment method. A credit card is on file so the user selects the correct past record and clicks ‘submit order’. Then
xi) User is shown order confirmation page which describes the order number and confirms the order details.

What is needed is a system and method for allowing end users (e.g., of mobile devices and/or desktop computers) to purchase one or more items quickly, efficiently, and seamlessly in response to receiving an email from, for example, an ecommerce vendor. For example, what is needed is a system and method that enables one or more of the steps (i)-(xi) identified above (e.g., any one or more, or all, of step(s) (i), (ii), (iii), (iv), (v), (vi), (vii), (viii), (ix), (x), and/or (xi)) to be eliminated (i.e., no longer required).

### SUMMARY

In one aspect, a system is described that can include one or more server computers and a non-transient machine-readable medium storing instructions which, when executed by the one or more server computers, cause the one or more server computers to: generate an email comprising a user-selectable option for a user to purchase one or more items referenced in the email, wherein the user-selectable option is personalized to a user and, upon selection, causes information regarding the user and a purchase order request to be transmitted to the one or more servers; send the email to an email address associated with the user; receive information regarding the user and the purchase order request subsequent to a user-selection of the user-selectable option via a user device; and validate or decline a purchase transaction based at least in part on the receipt of information regarding the user and the purchase order request.

In some variations, one or more of the following can be implemented either individually or in any feasible combination. The one or more server computers can be configured to activate a user token referenced in the email in response to receiving a communication indicating that the email has been opened on a user device. The one or more server computers can be further configured to deactivate the user token and prevent a purchase transaction from the email if the user-selectable option of the email is not selected within a predetermined time after the receipt of the communication indicating the opening of the email on the user device.

The one or more server computers can be configured to validate or decline a purchase transaction based at least in part on one or more items of validation data selected from the group consisting of: internet protocol (IP) address of a user device from which the user-selectable option was selected, location of the user device, fingerprint data received via the user device, iris scan data received via the user device, UserAgent from email client of the user device, UserAgent from browser of the user device, user device width, version number of a browser of the user device, e-tag from the user device, cookie from the user device, language of the user device, color depth of the user device, screen resolution of the user device, Timezone of the user device, status of the user device having session storage or not, status of the user device having local storage or not, CPU class of the user device, platform of the user device, DoNotTrack or not of the user device, list of installed fonts (maintaining their order, which increases the entropy) of the user device, status of whether AdBlock is installed or not on the user device, status of whether a user has tampered with or changed the user device languages, status of whether a user has tampered with or changed the user device screen resolution, status of whether a user has tampered with or changed the user device operating system (OS), status of whether a user has tampered with or changed the user device browser, touch screen detection and capabilities of the user device, and pixel ratio of the user device. The one or more server computers can be configured to receive the one or more items of validation data from the user device.

The user device can be a mobile device. The one or more computers can be configured to generate the email based at least in part on the receipt of data indicating that the user has visited or otherwise interacted with a website associated with the one or more items. The data can include data indicating that the user has signed up for a newsletter associated with the website. The data can include data indicating that the user has browsed the website for products. The data can include data indicating that the user has added at least one of the one or more products to a web shopping cart but did not complete a purchase.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

### BRIEF DESCRIPTION OF THE DRAWINGS

For a better understanding of some implementations of the present subject matter and to show how the same may be carried into effect, reference will now be made, by way of example, to the accompanying drawings in which like numerals and/or characters designate corresponding elements or sections throughout. In the accompanying drawings:

FIG. 1A illustrates the operation of system and method for enabling a user to purchase one or more items in response to receiving an email, in accordance with some implementations of the present subject matter, where the user reviews some or all of the order details (e.g., via a web browser) before completing the purchase;

FIG. 1B illustrates the operation of system and method for enabling a user to purchase one or more items in response to receiving an email, in accordance with some implementations of the present subject matter, where the purchase scenario does not involve an order review step and the order is confirmed directly from the email;

FIG. 1C illustrates a computing landscape that enables a user to purchase one or more items in response to receiving an email, which can be in accordance with the implementations of either FIG. 1A or FIG. 1B;

FIG. 1D illustrates that the server system enables users of different electronic commerce applications—e.g., first electronic commerce application and second electronic commerce application—to purchase one or more items sold on the corresponding electronic commerce application in response to receiving an email;

FIG. 1E illustrates one example of the server being a cloud computing server;

FIG. 2A is a flow diagram illustrating various steps that may be performed by systems and methods in accordance with various implementations of the present subject matter, for example, in connection with and/or leading to the illustrative displays shown in FIG. 1A; and

FIG. 2B is a flow diagram illustrating various steps that may be performed by systems and methods in accordance with various implementations of the present subject matter, for example, in connection with and/or leading to the illustrative displays shown in FIG. 1B.

Like reference characters in different drawings indicate like elements.

### DETAILED DESCRIPTION

With specific reference now to the drawings in detail, it is to be understood that the particulars shown are by way of example and for purposes of illustrative discussion of preferred implementations of the present subject matter only. The description taken in conjunction with the drawings will make apparent to those of ordinary skill in the art how the several forms and implementations of the subject matter may be embodied in practice.

It is also to be understood that implementations of the subject matter are not limited in their application to the details of construction and the arrangement of the components set forth in the following description or illustrated in the drawings. Implementations of the subject matter may be practiced or carried out in various other ways. In addition, it is to be understood that the phraseology and terminology employed herein is for the purpose of description and should not be regarded as limiting.

In some implementations of the present subject matter, the systems and methods described herein may solve one or more (e.g., one, two, three, four, or all) of the following challenges in connection with allowing a user to seamlessly purchase one or more items in response to receiving an email from, for example, an ecommerce vendor:
Providing a solution in the event that the email is forwarded to someone else
Providing a solution in the event that a customer does not have payment details on file
Providing a solution in the event that a foreign individual, institution, or other party intercepts the original email
Providing a solution in the event that the price/availability of the one or more items changes after the email is sent
Providing a solution to facilitate payment without system service knowing, for example, the shop store's secret key for use with a payment application programming interface (API).

In some implementations of the present subject matter, the systems and methods described herein provide a way for users (e.g., customers for which the billing and shipping details are already on file, e.g., stored in accessible computer memory or database) to seamlessly purchase from email. In some implementations, emails sent to end users have personalized links which either directly confirm the purchase or redirect to personalized and/or pre-completed check out pages for a user to confirm the order details as well as shipping and/or payment details. Additional details in accordance with various implementations of the present subject matter are described below.

In some implementations of the present subject matter, the systems and methods described herein utilize a unique code for a user (e.g., a unique code contained in or otherwise originating from or related to an email with a personalized link sent to the user) as well as one or more (e.g., multiple) other factors associated with the user's session (e.g., IP address, location, browser type, screen size, email user agent string and/or browser cookie) and/or a probabilistic model to assess the validity of the user's purchase request. Alternatively or additionally, the systems and methods described herein may utilize biometric data (e.g., fingerprint/iris scan/face scan) to assess the validity of the user's purchase request.

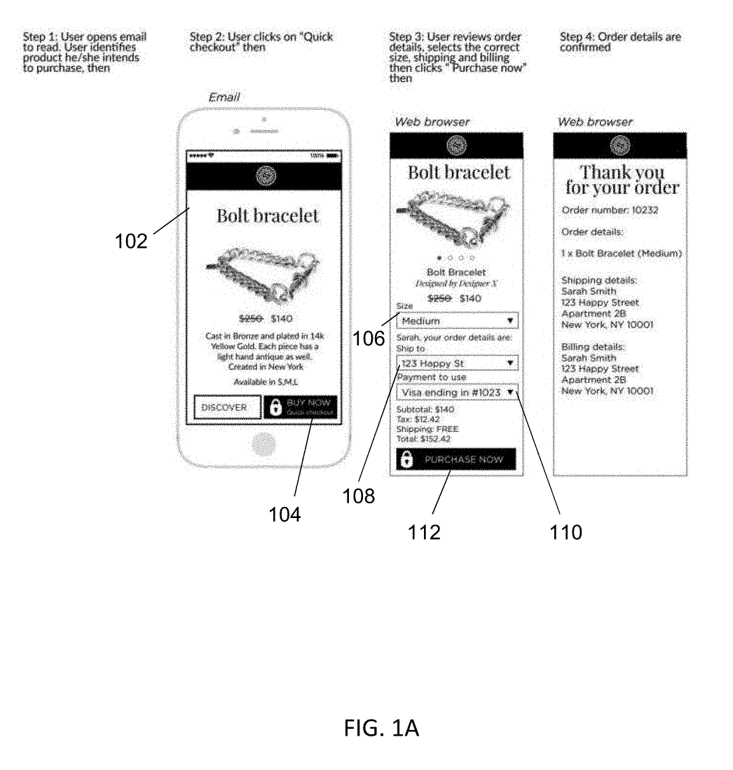

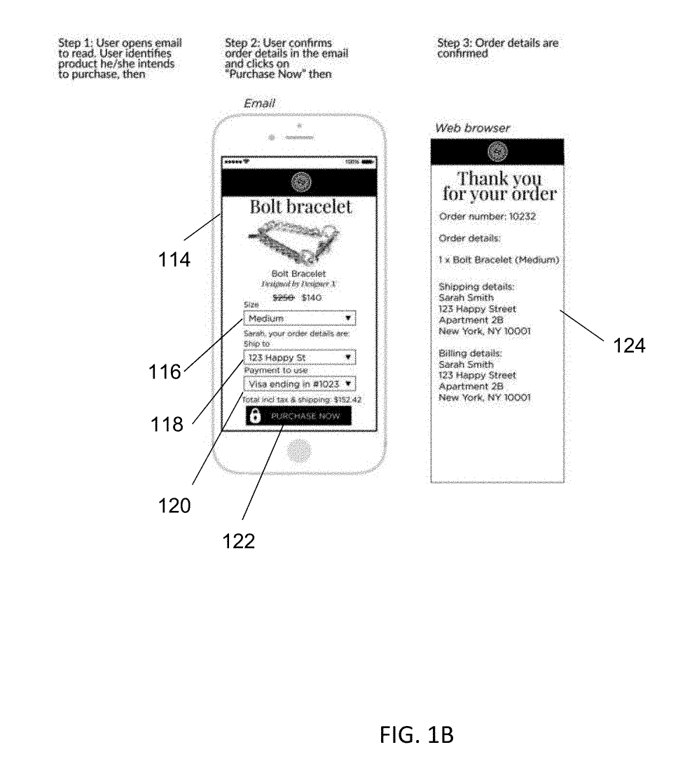

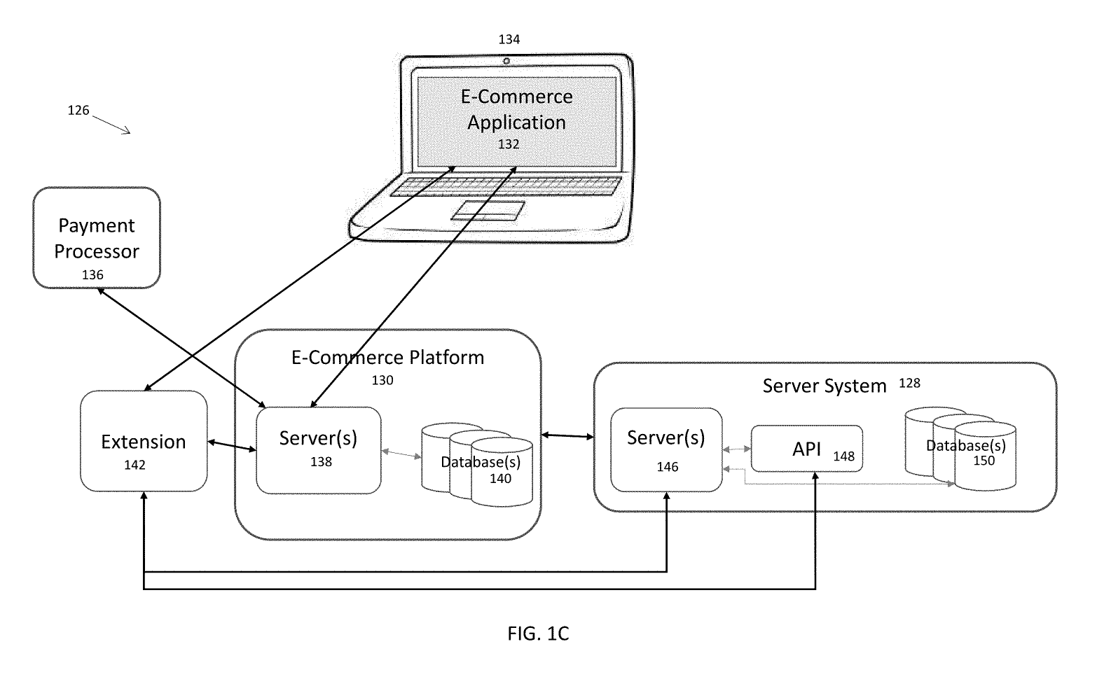

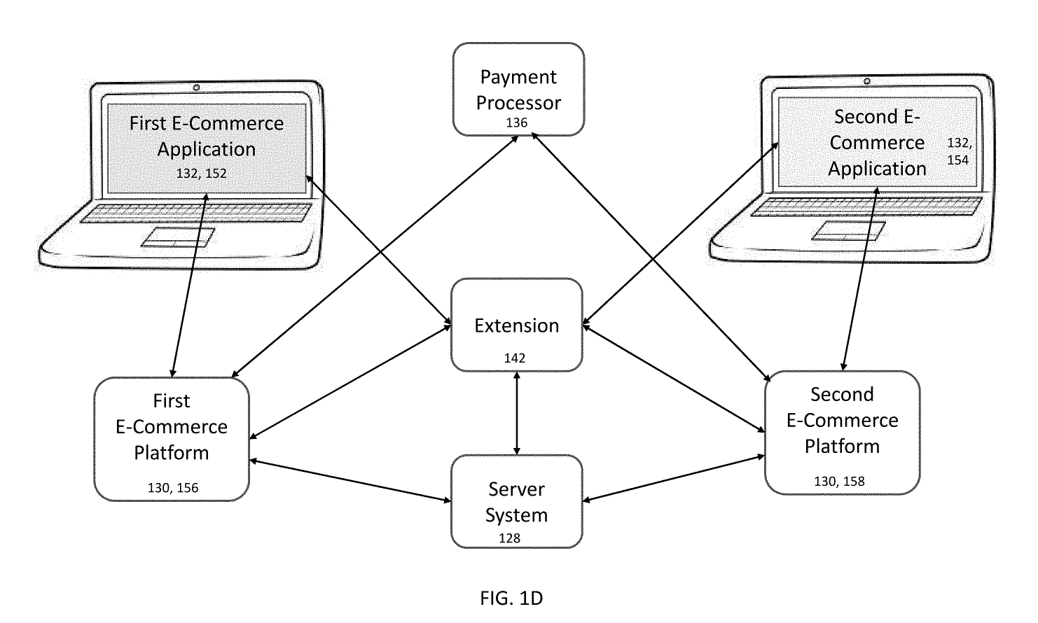

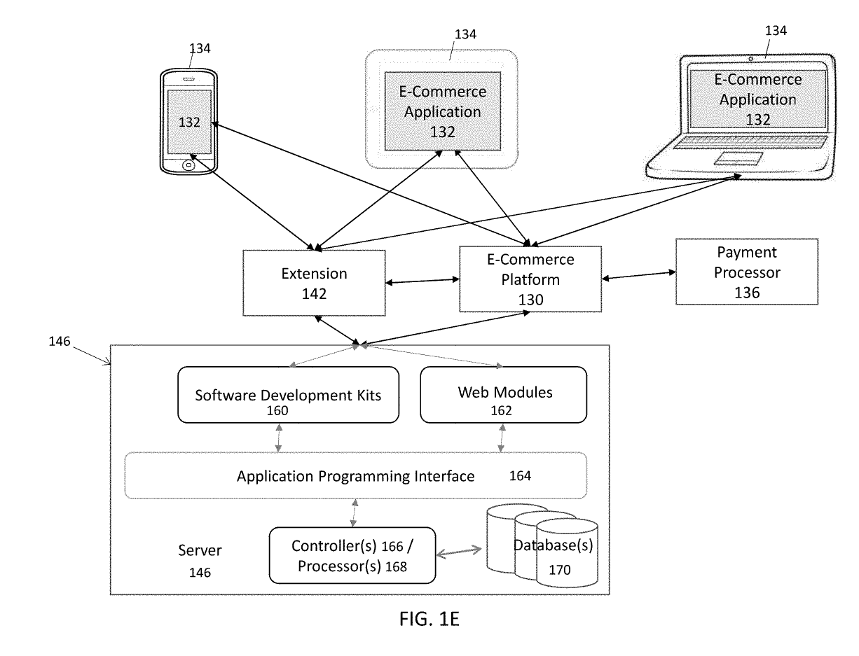

Turning now to the figures, FIGS. 1A and 1B illustrate two variations or use cases of systems and methods for enabling a user to purchase one or more items in response to receiving an email, in accordance various implementations of the present subject matter. The version or use case illustrated in FIG. 1A is for the scenario, for example, when an email client on the user's device (e.g., mobile phone or desktop computer) cannot render all the required information in a satisfactory way or when the ecommerce shop owner would like users to review some or all of the order details before completing the purchase. As shown in FIG. 1A, in a first step, a user opens an email 102 to read (e.g., using a device such as a mobile phone or other mobile device, or a desktop computer) and the user identifies a product he/she intends to purchase. In a second step, the user selects (e.g., “clicks” via a finger press) an option displayed in the email (e.g., “Quick checkout” option 104). In a third step, the user reviews order details and/or makes one or more selections (e.g., selects correct sizing for the item(s) 106, shipping information 108, and/or billing information 110 through a web browser on the user's device) and selects (e.g., “clicks”) an option to complete the purchase (e.g., selecting “Purchase Now” option 112 through the web browser). In a fourth step, the order details are confirmed through, for example, a web browser display on the user's device. Thus, in some implementations as illustrated in FIG. 1A, only two responsive submissions (e.g., from the user's device to one or more servers), which submissions are triggered by user “clicks,” are required to complete the purchase.

FIG. 1B illustrates the scenario, for example, wherein the purchase scenario does not involve an order review step and the order is confirmed directly from the email. As shown in FIG. 1B, in a first step, a user opens an email 114 to read (e.g., using a device such as a mobile phone or other mobile device, or a desktop computer) and the user identifies a product he/she intends to purchase. In a second step, the user confirms the order details and/or makes one or more selections in the email (e.g., selects correct sizing for the item(s) 116, shipping information 118, and/or billing information 120) and selects (e.g., “clicks”) an option in the email to complete the purchase (e.g., selecting “Purchase Now” option 122 in the email). In a third step, the order details are confirmed through, for example, a web browser display on the user's device. Thus, in some implementations as illustrated in FIG. 1B, only one responsive submission (e.g., from the user's device to one or more servers), which submission is triggered by a user “click,” is required to complete the purchase. In some implementations, the systems and methods described herein operate such that in cases where a vendor (e.g., shop owner) would prefer the version shown in FIG. 1B but knows that not all customers' email clients can render the page correctly, the email defaults back to the version shown in FIG. 1A.

For ease of reference, the two scenarios illustrated in connection with FIGS. 1A and 1B are sometimes referenced herein as “Quick purchase from email functionality” or similar. In some implementations, the Quick purchase from email functionality is a feature that aims to increase the conversion rate for an ecommerce website. It makes it easier for an existing customer to purchase from email. In various implementations according to the present subject matter, this feature can be integrated into broadcast emails where the same content is sent to everyone as well as personalized emails where the content is personalized for every recipient.

FIG. 1C illustrates a computing landscape 126 that enables a user to purchase one or more items in response to receiving an email, which can be in accordance with the implementations of either FIG. 1A or FIG. 1B. The computing landscape 126 can include a server system 128, an electronic commerce platform 130 that can host an electronic commerce application 132 (which can be a website or an application that can be installed and executed on a mobile device such as a smart phone or a tablet computer), a computing device 134 that displays the electronic commerce application 132, and a payment processor 136. The server system 128 can enable the electronic commerce platform 130 to process, via an extension 142 and using the payment processor 136, payment of one or more items displayed and sold on the electronic commerce application 132.

The computing device 134 can be configured to be accessed by a user. The electronic commerce platform 130 can be configured to be managed and run by an electronic commerce merchant, which can also be referred as an electronic commerce store owner or simply a store owner. The electronic commerce platform 130 can include one or more servers 138, one or more databases 140. The electronic commerce platform 130 can be operably coupled to the extension 142, which can be provided, managed, and controlled by the server system 128. The one or more servers 138 can host the electronic commerce application 132. The one or more databases 140 can store historical data of various customers of the electronic commerce application 132, such as financial preferences and records of as well as frequency of purchase by those customers. The extension 142 can modify the programming code of the electronic commerce application 132, and may also be referred to as a plug-in, plug in, add-in, addin, add-on, addon, an application (e.g., SHOPIFY, which has an application store) or the like in the electronic commerce application 132. The extension 142 can be a specific web-page occupying either the entire screen of the computing device 134, or a pop-up window that occupies a part of that screen as shown. The extension 142 can be one or more software tools that can automate the process of installing, upgrading, configuring, and removing computer programs specific to the electronic commerce application 132. Data associated with the electronic commerce platform 130 can be stored in the one or more databases 140.

The server system 128 can include one or more servers 146, an application programming interface (API) 148, and one or more databases 150. The one or more servers 146 can control the extension 142. The payment processor 136 can receive payment data from the extension 142 via the one or more servers 138 of the electronic commerce platform 130, and the API 148 can in turn enable the one or more servers 146 to read the payment data at the payment processor 136. The API 148 can communicate with the extension 142, either directly, or indirectly via the one or more servers 146. Data associated with the server system 128 can be stored in the one or more databases 150.

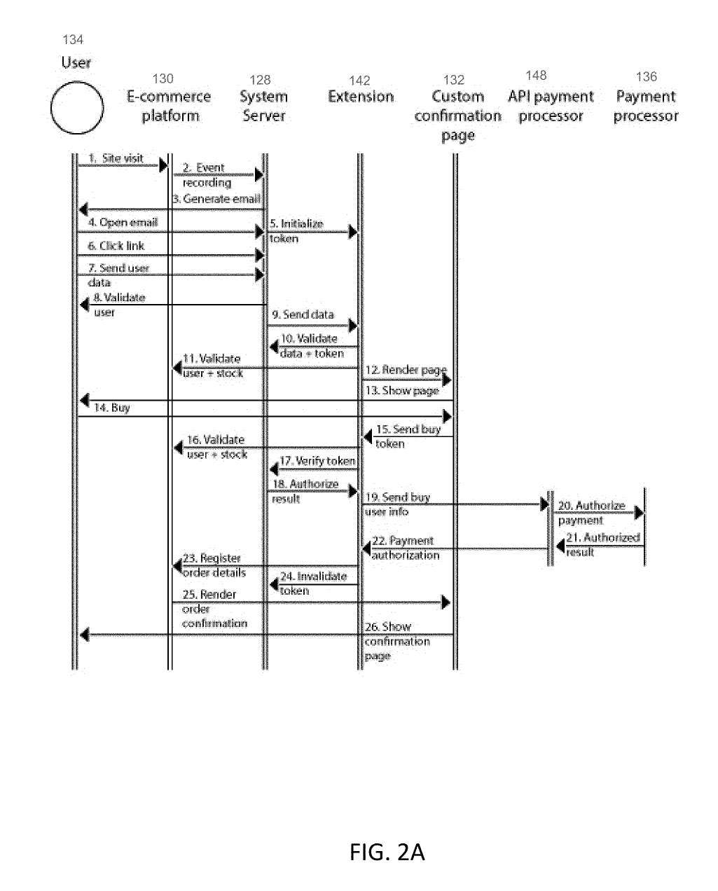

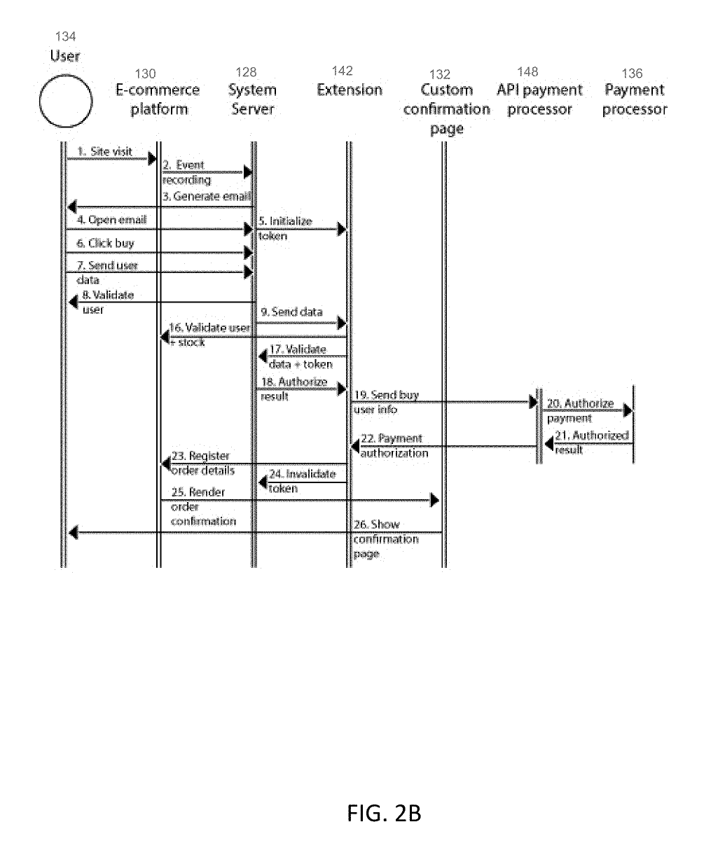

The functionality of various components of the computing landscape is described in further detail by FIGS. 2A and 2B.

FIG. 1D illustrates that the server system 128 enables users of different electronic commerce applications 132—e.g., first electronic commerce application 152 and second electronic commerce application 154—to purchase one or more items sold on the corresponding electronic commerce application 152/154 in response to receiving an email. The different electronic commerce applications 132 are hosted by different electronic commerce platforms 130—e.g., first electronic commerce platform 156 and second electronic commerce platform 158.

FIG. 1E illustrates one example of the server 146. In this example, the server 146 can be a cloud computing server. The cloud computing server 146 can include software development kits 160, web modules 162, an API 164, one or more controllers 166 including one or more processors 168, and one or more databases 170 connected to the one or more controllers 166. The API 164 can be separate from and in addition to the API 148. The one or more databases 170 can be either in addition or as an alternate to the one or more databases 150.

In a few implementations, some or all of the one or more servers 138 can also be a cloud computing server, which can include software development kits, web modules, an API, one or more controllers including one or more processors, and one or more databases connected to the one or more controllers.

Use of cloud computing servers can be advantageous, as they are quickly scalable (e.g., can be added in a few seconds) when there is a need to add a server (e.g., due to a load increase on an application hosted by the cloud server). Additionally, inclusion of all of the one or more software development kits, one or more web modules, API, at least one data processor, and database within the cloud computing server advantageously enables a dynamic provisioning, monitoring and managing of infrastructure, all of which further enables easily restoring the entire system to a previous version if and when required.

FIG. 2A is a flow diagram illustrating various steps that may be performed in accordance with various implementations of the present subject matter, for example, in connection with and/or leading to the illustrative displays shown in FIG. 1A where the user views an order review page via a web browser before completing a purchase. FIG. 2A illustrates actions that may be performed, received, and/or triggered by various entities, and or the results of those actions, including:
The user who receives the email (and the user's associated device 134, e.g., a mobile device such as a mobile phone or a desktop computer)
An ecommerce platform 130 (e.g., one or more computer servers) managed and run by the shop owner (e.g., MAGENTO, SPREE, WOO COMMERCE, SHOPIFY, DEMANDWARE, and/or the like)
A system server 128, which may be one or more server computer(s), which may generate the original email, validate the user, and/or provide the necessary check(s) to enable the system to function
Extension 142: an extension or add on (e.g., software extension) which the shop owner needs to install to the shop code base (e.g., an extension to the ecommerce platform 130) to enable the extra functionality to work with his/her shop
Custom confirmation page on the electronic commerce application 132: the page which gets rendered and is displayed on the user's device 134, which may be different for each user and may show (i) the order details to review and/or modify or (ii) the order confirmation details
API 148 for the payment processor 136: the API 148 (e.g., from STRIPE or BRAINTREE) which interacts with the ecommerce platform 130 and the payment processor 136 to send necessary information (e.g., necessary customer token id) to enable payment to be processed.
Payment processor 136: the payment processor 136 which ultimately makes sure the customer is billed for the purchase.

In various illustrative implementations described herein, it is contemplated that one or more (e.g., some or all) of the inventive features described herein may be implemented by one or more system server computers 128 and associated software that integrate with an existing ecommerce platform 130. In other implementations according to the present subject matter, one or more (e.g., some or all) of the functions described herein may be performed by one or more servers 138 of the ecommerce platform 130 itself. For example, in some implementations, software associated with the ecommerce platform 130 may include logic for causing the one or more servers 138 of the ecommerce platform 130 to perform one or more functions including, for example, generating the original email containing, for example, purchase links and/or other information as described herein, validating the user, and/or providing the necessary check(s) to enable the system to function as described herein.

As shown in FIG. 2A, at step 1, the user may visit the website/application 132 and interact with the content on the website 132. For example, the user might sign up for a newsletter, browse for products, add something (e.g., one or more items) to a cart (e.g., without completing a purchase) or even complete a purchase.

At step 2, the system server 128 may record one or more key event(s), e.g., newsletter signup, viewed a product, added a product to the cart, searched a product or completed a purchase. These events may allow the system server 128 to know which customers have payment and/or shipping details on file as well as recommend products which he/she might like. The recommended products may be determined by the system server 128 based on one or more learning algorithms, such as: group method of data handling, Naive Bayes, k-nearest neighbor algorithm, majority classifier, support vector machines, random forests, boosted trees, classification and regression trees (CART), multivariate adaptive regression splines (MARS), neural networks, ordinary least squares, generalized linear models (GLM), logistic regression, generalized additive models, robust regression, semiparametric regression, any other predictive model, and/or any other learning algorithm.

At step 3, the system server 128 may generate the hypertext markup language (HTML) (or otherwise marked up) email and sends it to the user. In some implementations, this can be based on rules associated with events from Step 2 (e.g., abandoned cart email) or a broadcast email which is the same for everyone on the shop owner's email list. In some implementations, this can be a hybrid where some content is the same for everyone and some content or product recommendations are personalized.

In some implementations, the quick purchase links associated with any product (or bundle of products) may be personalized for every user (even if the content of the email is not unique) and include an anonymized variable (e.g., “XY”) which can be decoded to incorporate one or more (e.g., all) of:
The user's email address
Order details (e.g., variant ID, size, color, quantity)
Unique token (“X”)
   In some implementations, the unique token “X” is a complex and unique variable which is used in conjunction with other variables (e.g., Internet Protocol (IP), fingerprint, iris scan) to validate the user. For example, without the unique token, a user cannot pass through the various validation steps.

In some implementations, the systems and methods described herein may only display quick purchase links where the user's shipping and/or payment details are already on file (i.e., stored in the one or more databases 140 or 150). Note that in some implementations steps 1 & 2 may not be needed if the system server 128 is given a list of emails where the person's shipping and/or payment details are already on file and the content for the email does not need to be personalized based on each user's profile.

In some implementations, for users who do not have the shipping and/or payment details on file, the system server 128 may send a modified email without quick purchase links. These links instead direct the user to the cart or various pages on the website 132, e.g., product page, home page, article page, and/or the like where users can check out items in a traditional manner.

At step 4, after the email is opened (e.g., as soon as the email is opened, namely, in response to the email being opened), a tracking beacon may be sent for the open event to a support server, which can be one of the server(s) 146. This may then cause the support server 146 to initialize the token “X” (Step 5) for a set period of time (e.g., about 20 minutes, 30 minutes, one hour, etc.). In some implementations, if the following steps are not completed in that time window, the token expires and the quick purchase functionality will not work for that email.

At step 6, the user may click, on the computing device 134, a Quick checkout link to redirect to a web-browser, native app or other ecommerce shop front end 132 which sends relevant information to the support server 146 (Step 7).

At step 8, the information from Step 7 may be received and may depend on the device 134 and browser and/or the amount of user history. The information received can include one or more of (but is not limited to):

Internet Protocol (IP) address (and associated location)

Fingerprint

Iris Scan

Face Scan

UserAgent from email client

UserAgent from browser

Device width (e.g., width of the device screen in CSS pixels at a scale of 100%)

Browser version number

E-tag

Cookie

Language

Color Depth

Screen Resolution

Timezone

Has session storage or not

Has local storage or not

CPU class

Platform

DoNotTrack or not

Full list of installed fonts (maintaining their order, which increases the entropy)

Is AdBlock installed or not

Has the user tampered with its languages

Has the user tampered with its screen resolution

Has the user tampered with its OS

Has the user tampered with its browser

Touch screen detection and capabilities

Pixel Ratio

In some implementations, one or more items of this information may be compared to previous session information to help identify if it is the same user. In some implementations, this information may be different for every email client (e.g., checking on your phone will generate different information than checking on your laptop). In some implementations, this information may also change when a user upgrades phones or upgrade browsers on your devices. Given that this information may be changing, one or more rules may be used to assess the probability the request is fraudulent. For example, if the IP and/or location and/or the browser version number are consistent with the past 10 browsing sessions, the session might be marked as suspicious if multiple other variables are new (e.g., Has the user tampered with its languages, Has the user tampered with or changed its screen resolution, Has the user tampered with or changed its OS, Has the user tampered with or changed its browser); otherwise the request may be approved. In some implementations, if the IP/location represent a new country, and in some implementations depending on the site owner's risk tolerance, the link may be disabled by default. In some implementations, the one or more rules are custom developed based on the site owner's risk tolerance.

In some implementations, the unique token alone may be used for user verification as it may be enough to make the system very secure. In some implementations, a combination of unique user data points and the associated rules may be used and may render the systems and methods even more secure.

In some implementations, if the site owner wishes to have one or more flexible rules and then monitor the results, sessions can be marked as suspicious and then post purchase manually checked for potential fraud. This allows for potential markers for fraud to be assessed over time and be used to improve the rules. This approach is helpful when, for example, the shop owner's customers travel frequently and/or regularly update their technology. Given the potential customers for this quick checkout feature are already existing customers (who have passed fraud checks to have their first order delivered), most sessions requests are likely to be legitimate.

In some implementations, a machine learning process loop can be incorporated into the monitoring, validation and rule setting to further optimize the user validation rules employed to optimize revenue while minimizing issues with fraud.

At step 9, if the support server 146 validates the user data, the anonymized variable (e.g., “XY”) which may include one or more (e.g., all) of following details may be sent through to the Extension:

The user's email address

Order details (e.g., variant ID, size, color, quantity)

Unique token (“X”)

At step 10, the extension 142 may then send a validation request to the support server 146 to make sure the token is currently valid and the information it received is accurate.

At step 11, once the extension 142 has validated the information it has received, it may communicate with the ecommerce platform 130 to make sure the customer details are on file and the products which are to be included in the order are in stock.

At step 12, if the extension 142 validates at least some (e.g., all) of the steps above, it may generate a customized order confirmation page (e.g., as per FIG. 1A). The design of this page may be customized to meet the shop owner's specifications.

At step 13, the customized page may be shown to the user in the application 132. From the user perspective, this may happen immediately after and in response to the user clicking on the Quick checkout link (Step 6). In some implementations, the intermediate steps happen, transparent to the user and behind the scene, extremely quickly (e.g., in real-time) to enable a simple and convenient customer experience. If the intermediate steps are not validated, the user receives a quick notification informing them the quick checkout link is currently invalid (e.g., and a reason given if appropriate) and may offer an alternate check out experience, such as being redirected to the checkout page, their cart or another appropriate next step. Under some circumstances (e.g., token has timed out), in some implementations the user may be offered options to restart the Quick Purchase from Email process, like clicking a button to request a new email to restart the process. In this case a new email may be sent to the user with a new anonymized variable (e.g., “XY”).

In some implementations, assuming the steps are validated, the user may select, on the application 132, from various shipping and/or billing details on file and possibly other related details (e.g., with the most recently used details set as the default option) and changes any order details as needed.

At step 14, the user may then confirm the order by clicking the purchase now button (see e.g., FIG. 1A). In some implementations, the user may be required to further validate the purchase intent with a fingerprint or iris scan (e.g., depending on the site owner's risk tolerance).

At step 15, the extension 142 may receive information (e.g., the buy token) from the custom page, which may signal to the extension that the user wishes to complete the purchase.

At step 16, the extension 142 may then once again check against the ecommerce platform 130, for example, to make sure that that the product has not gone out of stock, and/or whether any other condition(s) that may make it impossible to fulfil the order have changed, in the time between Step 11 and Step 16. It may also reconfirm that the user details match the variables on file. Alternatively or additionally, in some implementations, it may also ask the support server 146 to verify the received information (e.g., token) (step 17) to make sure the received information has not since expired.

At step 18, if the received information (e.g., token) is still valid, the support server 146 may confirm this to the extension.

At step 19, the extension 142 may send the payment token details to the payment processor 136 via the API 148 to have the payment processor 136 authorize the payment (Step 20).

At step 21, the payment processor 136 may confirm if the payment method (e.g., credit card, debit card, APPLE pay, PAYPAL, and/or any other payment method) can be charged and may sends the result via the API 148 (Step 21) to the extension 142 (Step 22).

At step 23, the extension 142 may send the full order details to the ecommerce platform 130 to incorporate into the order fulfillment process. This may generate an order confirmation number and reduce the overall inventory levels down by the quantity purchased.

At step 24, while this (e.g., Step 23) is happening, the extension 142 may inform the support server 146 that the token used should be invalidated.

At step 25, the ecommerce platform 130 may render the order confirmation page which includes the full order details.

At step 26, the user may be shown the order confirmation page with all the order details. From a user point of view, if the payment processing and other validation steps are confirmed, this page may be displayed for the user, for example, immediately after Step 14. The order fulfillment and confirmation notifications (e.g., order confirmation email) may now proceed as per the settings and processes set up by the shop owner.

FIG. 2B is a flow diagram illustrating various steps that may be performed by the systems and methods in accordance with various implementations of the present subject matter, for example, in connection with and/or leading to the illustrative displays shown in FIG. 1B where, for example, the purchase scenario does not involve an order review step via a web browser and the order is confirmed directly from an email. In some implementations, relative to the process flow illustrated in FIG. 2A, in the process flow implemented by the systems and methods according to FIG. 2B steps 10-15 may be eliminated in their entirety as not required. In some implementations of the present subject matter, the process flow illustrated in FIG. 2B may have the following similarities and differences relative to the process flow illustrated in FIG. 2A:
Step 1: Same as or similar to FIG. 2A
Step 2: Same as or similar to FIG. 2A
Step 3: For the scenario illustrated in FIG. 1B, the support server may generate an HTML (or otherwise marked up) email and send it to the user. The quick purchase link(s) may be personalized for every user (e.g., even if the content of the email is not unique) and may include an anonymized variable (e.g., “XYZ”) which can be decoded to incorporate one or more (e.g., all) of:
   The user's email address
   Order details (e.g., variant ID, size, color, and/or quantity)
   Unique token (e.g., “X”)
   Buy token (e.g., “Z”)
      In some implementations, this link with the Variable Z may inform the support server that the order can be confirmed straight away without the need for steps 10-15. For example, in some implementations, the email may be coded such that if the email client cannot display the page correctly with the required drop down boxes (e.g., as per FIG. 1B, for example, because the user has an older mobile phone) a simplified version is shown with a link which includes a different anonymized variable (e.g., “XY”). Thus, in such circumstance, the user may experience the quick purchase as per FIG. 1A where the user sees an order confirmation page before completing the purchase. In some implementations, for the scenario illustrated in FIG. 1B of the quick purchase, all emails may include two personalized links and two anonymized variables; however, only the one associated with the user experience enabled by the user's device 134 may be displayed to the user.
Step 4: Same as or similar to FIG. 2A
Step 5: Same as or similar to FIG. 2A
Step 6: In some implementations, the link may now be labeled so the user realizes he/she is now confirming the order when clicking. The ‘purchase click’ may then send relevant information to the support server 146 (Step 7). In some implementations, the user may be required to further validate the purchase intent with, for example, a fingerprint and/or iris scan (e.g., depending on the site owner's risk tolerance).
Step 8: Same as or similar to FIG. 2A
Step 9
if the support server 146 validates the user data, the anonymized variable (e.g., “XYZ”) which may include one or more (e.g., all) of following details may be sent through to the extension 142:
   The user's email address
   Order details (e.g., variant ID, size, color, quantity)
      Unique token (“X”)
      Buy token (e.g., “Z”)
This link with the Variable Z informs the support server that the user wishes to complete the purchase.
Step 16-Step 26: Same as or similar to FIG. 2A

In accordance with some implementations of the present subject matter, the systems and methods described herein solve one or more (e.g., one, two, three, four, or all) of the following challenges in connection with allowing a user to seamlessly purchase one or more items in response to receiving an email from, for example, an ecommerce vendor, as follows:
What happens if the email is forwarded to someone else?
   If the email is forwarded to someone else, one of two things may happen. If the second user opens it after the expiry of the token (e.g., after 20 minutes), the link may be invalidated as having timed out. If the link is still valid, the user data checks (e.g., steps 7 and/or 8 described above) may invalidate the token.
What happens if a customer does not have payment details on file?
   The system may be set up such that only people with payment details on file receive emails with quick purchase from email links. However, if for some reason that does not happen Step 11 and/or 16 as identified above may identify that error and inform the support server of the error and redirect the user to a product page instead.
What happens if a foreign player or entity intercepts the original email?
   Steps 7 and/or 8 as described above may identify the issue and invalidate the link.
What happens if the price and/or availability changes after the email is sent?
   Step 11 and/or Step 16 may confirm the price and availability and update accordingly.
How do you facilitate payment without the system server knowing the shop store's secret key for use with the payment API?
   The support server 146 may not need to know the shop store's secret key. In some implementations, it may confirm the user and the order details and pass that information along to the extension 142. The secret key may stay within the ecommerce platform 142 and/or the extension 142 and allow the communication with the payment processor 136. In some implementations, the ecommerce platform 130 and payment processor 136 may communicate in a similar manner to any other regular purchase made without the quick purchase feature.

In some implementations of the present subject matter, the systems and methods may be implemented in such a way that one or more (e.g., many) ecommerce platforms can take advantage of this quick purchase feature, including its process for order fulfillment, stock management, and/or payment processing, even if the underlying platform does not support quick purchase from email.

In some implementations, the systems and methods may seamlessly facilitate payment without storing sensitive payment information (e.g., including the shop owner's secret key).

In some implementations, the systems and methods may use a unique token alone or in combination with one or more user data points (e.g., IP, fingerprint, iris scan) to validate the user. In some implementations, the unique token may alone be enough to make the system very secure. With the combination of a unique token and user data points, the system may be extremely secure.

In some implementations, the systems and methods may utilize a rules based approach to validating the user that is flexible and highly adaptable, for example, with the use of machine learning.

In some implementations, the systems and methods may support purchase of one or multiple products with 1 or 2 clicks.

In some implementations, the systems and methods may support direct purchase from email as well as providing an order confirmation page in a seamless manner which varies based on which email client is used.

In some implementations, the systems and methods may utilize a unique token to support customer verification and/or prevents third party interference with the system.

Various implementations of the subject matter described herein can be realized/implemented in digital electronic circuitry, integrated circuitry, specially designed application specific integrated circuits (ASICs), computer hardware, firmware, software, and/or combinations thereof. These various implementations can be implemented in one or more computer programs. These computer programs can be executable and/or interpreted on a programmable system. The programmable system can include at least one programmable processor, which can be a special purpose or a general purpose processor. The at least one programmable processor can be coupled to a storage system, at least one input device, and at least one output device. The at least one programmable processor can receive data and instructions from, and can transmit data and instructions to, the storage system, the at least one input device, and the at least one output device.

These computer programs (also known as programs, software, software applications or code) can include machine instructions for a programmable processor, and can be implemented in a high-level procedural and/or object-oriented programming language, and/or in assembly/machine language. As can be used herein, the term “machine-readable medium” can refer to any computer program product, apparatus and/or device (for example, magnetic discs, optical disks, memory, programmable logic devices (PLDs)) used to provide machine instructions and/or data to a programmable processor, including a machine-readable medium that can receive machine instructions as a machine-readable signal. The term “machine-readable signal” can refer to any signal used to provide machine instructions and/or data to a programmable processor.

To provide for interaction with a user, the subject matter described herein can be implemented on a computer that can display data to one or more users on a display device, such as a cathode ray tube (CRT) device, a liquid crystal display (LCD) monitor, a light emitting diode (LED) monitor, or any other display device. The computer can receive data from the one or more users via a keyboard, a mouse, a trackball, a joystick, or any other input device. To provide for interaction with the user, other devices can also be provided, such as devices operating based on user feedback, which can include sensory feedback, such as visual feedback, auditory feedback, tactile feedback, and any other feedback. The input from the user can be received in any form, such as acoustic input, speech input, tactile input, or any other input.

The subject matter described herein can be implemented in a computing system that can include at least one of a back-end component, a middleware component, and/or a front-end component, or one or more combinations thereof. The back-end component can be one or more data server(s). The middleware component can be an application server. The front-end component can be a client computer having a graphical user interface or a web browser, through which a user can interact with an implementation of the subject matter described herein. The components of the system can be interconnected by any form or medium of digital data communication, such as a communication network. Examples of communication networks can include a local area network, a wide area network, internet, intranet, Bluetooth network, infrared network, or other networks.

The computing system can include clients and servers. A client and server can be generally remote from each other and can interact through a communication network. The relationship of client and server can arise by virtue of computer programs running on the respective computers and having a client-server relationship with each other.

Although a few variations have been described in detail above, other modifications can be possible. For example, the logic flows depicted in the accompanying figures and described herein are only implementations and do not necessarily require the particular order shown, or sequential order, to achieve desirable results.

In the above description, an implementation is an example or implementation of the present subject matter. The various appearances of “one implementation”, “an implementation” or “some implementations” do not necessarily all refer to the same implementations.

Although various features of implementations of the present subject matter may be described in the context of a single implementation, the features may also be provided separately or in any suitable combination. Conversely, although implementations of the present subject matter may be described herein in the context of separate implementations for clarity, the subject matter may also be implemented in a single implementation.

Implementations of the subject matter may include features from different implementations disclosed above, and implementations may incorporate elements from other implementations disclosed above. The disclosure of elements of some implementations of the subject matter in the context of a specific implementation is not to be taken as limiting their used in the specific implementation alone.

Furthermore, it is to be understood that implementations of the subject matter can be carried out or practiced in various ways and that implementations of the subject matter can be implemented in other ways than the ones outlined in the description above.

The subject matter is not limited to the diagrams or to the corresponding descriptions contained herein. For example, in a method according to some implementations of the present subject matter, the flow need not move through each illustrated step or state, or in exactly the same order as described.

Meanings of technical and scientific terms used herein are to be commonly understood as by one of ordinary skill in the art to which the invention belongs, unless otherwise defined.

While this specification refers to a limited number of implementations, these should not be construed as limitations on the scope of the invention, but rather as exemplifications of some of the preferred implementations. Other possible variations, modifications, and applications are also within the scope of implementations of the present subject matter. The following claims are illustrative only and non-limiting. Applicant may pursue other claims that are broader in some respects, and/or narrower in some respects, in a later-filed utility application that claims priority to this application.

1. A system comprising:
one or more server computers; and
a non-transient machine-readable medium storing instructions which, when executed by the one or more server computers, cause the one or more server computers to:
generate an email comprising a user-selectable option for a user to purchase one or more items referenced in the email, wherein the user-selectable option is personalized to a user and, upon selection, causes information regarding the user and a purchase order request to be transmitted to the one or more servers;
send the email to an email address associated with the user;
receive information regarding the user and the purchase order request subsequent to a user-selection of the user-selectable option via a user device; and
validate or decline a purchase transaction based at least in part on the receipt of information regarding the user and the purchase order request.

2. The system of claim 1, wherein the one or more server computers is configured to activate a user token referenced in the email in response to receiving a communication indicating that the email has been opened on a user device.

3. The system of claim 2, wherein the one or more server computers is further configured to deactivate the user token and prevent a purchase transaction from the email if the user-selectable option of the email is not selected within a predetermined time after the receipt of the communication indicating the opening of the email on the user device.

4. The system of claim 1, wherein the one or more server computers is configured to validate or decline a purchase transaction based at least in part on one or more items of validation data selected from the group consisting of: internet protocol (IP) address of a user device from which the user-selectable option was selected, location of the user device, fingerprint data received via the user device, iris scan data received via the user device, UserAgent from email client of the user device, UserAgent from browser of the user device, user device width, version number of a browser of the user device, e-tag from the user device, cookie from the user device, language of the user device, color depth of the user device, screen resolution of the user device, Timezone of the user device, status of the user device having session storage or not, status of the user device having local storage or not, CPU class of the user device, platform of the user device, DoNotTrack or not of the user device, list of installed fonts (maintaining their order, which increases the entropy) of the user device, status of whether AdBlock is installed or not on the user device, status of whether a user has tampered with or changed the user device languages, status of whether a user has tampered with or changed the user device screen resolution, status of whether a user has tampered with or changed the user device operating system (OS), status of whether a user has tampered with or changed the user device browser, touch screen detection and capabilities of the user device, and pixel ratio of the user device.

5. The system of claim 4, wherein the one or more server computers is configured to receive the one or more items of validation data from the user device.

6. The system of claim 1, wherein device is a mobile device.

7. The system of claim 1, wherein the one or more computers is configured to generate the email based at least in part on the receipt of data indicating that the user has visited or otherwise interacted with a website associated with the one or more items.

8. The system of claim 7, wherein the data comprises data indicating that the user has signed up for a newsletter associated with the website.

9. The system of claim 7, wherein the data comprises data indicating that the user has browsed the website for products.

10. The system of claim 7, wherein the data comprises data indicating that the user has added at least one of the one or more products to a web shopping cart but did not complete a purchase.
